(19) United States
(12) Patent Application Publication
(10) Pub. No.: US 2021/0163301 A1
(43) Pub. Date: Jun. 3, 2021

(54) METHOD FOR PRODUCING LARGE GRANULAR ALPHA-PHASE SILICON CARBIDE POWDERS WITH A HIGH-PURITY

(71) Applicant: KOREA INSTITUTE OF SCIENCE AND TECHNOLOGY, Seoul (KR)

(72) Inventors: Sang Whan PARK, Seoul (KR); Mi Rae YOUM, Seoul (KR); SUNG IL YUN, Seoul (KR)

(73) Assignee: KOREA INSTITUTE OF SCIENCE AND TECHNOLOGY, Seoul (KR)

(21) Appl. No.: 17/105,200

(22) Filed: Nov. 25, 2020

(30) Foreign Application Priority Data
Nov. 28, 2019 (KR) 10-2019-0155884

(51) Int. Cl. C01B 32/97; C01B 32/977

(52) U.S. Cl. CPC C01B 32/97; C01B 32/977; C01P 2004/52; C01P 2004/64; C01P 2004/61; C01P 2006/80

(57) ABSTRACT

The present disclosure provide a method for producing large granular high-purity α-phase silicon carbide powders using a silicon dioxide/carbon composite, the method including: producing a gel in which the carbonaceous compound is dispersed in a silicon dioxide network structure through a sol-gel process using starting materials including liquid phase silicon containing compounds and liquid phase carbonaceous compounds; subjecting the gel to first heat treatment to thermally decompose the carbon carbonaceous compound, thereby producing a silicon dioxide/carbon composite including nano-sized carbon particles; and subjecting the silicon dioxide/carbon composite to second heat treatment at a higher temperature than that of the first heat treatment to obtain large granular high-purity α-phase silicon carbide powders.

### CROSS-REFERENCE TO RELATED APPLICATION

This application claims under 35 U.S.C. §119(a) the benefit of priority from Korean Patent Application No. 10-2019-0155884 filed on Nov. 28, 2019, the entire contents of which are incorporated herein by reference.

### BACKGROUND

### (a) Technical Field

The present disclosure relates to a method of producing large granular α-phase silicon carbide powders with a high-purity using a silicon dioxide/carbon composites, and more particularly to a method of producing large granular high-purity α-phase silicon carbide powders using a silicon dioxide/carbon composites, the method including: preparing a gel, in which a carbonaceous compound is uniformly dispersed in the network structure of silicon dioxide, through a sol-gel process using liquid phase silicon containing compound and a carbonaceous compound as starting materials; drying the gel such that movement of the carbonaceous compound in the gel does not occur; heat-treating the dried gel to thermally decompose the carbonaceous compound, thereby producing a silicon dioxide/carbon composite in which carbon particles having a size of 5 nm or less are uniformly distributed; and subjecting the produced silicon dioxide/carbon composite to carbothermal reduction, thereby producing silicon carbide powders. More particularly, the present disclosure relates to a method for producing large granular high-purity α-phase silicon carbide powders, which enables control of the average particle size of high-purity α-phase silicon carbide powder by controlling the molar ratio of carbon/silicon in a silicon dioxide/carbon composite, the heat-treatment temperature and the heating time.

### (b) Background Art

In recent years, in the power semiconductor market, the need for materials having large band gaps and high dielectric breakdown characteristics has emerged for miniaturization of semiconductors and minimization of power loss. Currently, the demand for silicon carbide power semiconductors replacing Si semiconductor for high powder semiconductor devices is increasing rapidly, and accordingly, investment in the production of silicon carbide single crystals is increasing, and the market size of silicon carbide single crystals is rapidly growing.

In order to produce silicon carbide single crystals for power semiconductors, various single-crystal growth processes have been developed, including a liquid-phase epitaxy (LPE) method which grow SiC single crystals in a Si solution, a CVD method, and a physical vapor transport (PVT) method. However, 8-inch silicon carbide single crystal wafers with minimal defects are commercially produced only by the physical vapor transport (PVT) method. In the process of growing silicon carbide single crystals by the PVT method, various powder characteristics, such as the size and purity of silicon carbide powder used as a raw material, as well as the packing density of powders, have been known as important factors that determine the characteristics and growth rate of silicon carbide single crystals. However, information on the characteristics of the silicon carbide powder used for single-crystal growth by PVT method and the market of the silicon carbide powder have not been openly known. Since silicon carbide powders used as a raw material for the PVT process have been produced independently by SiC single crystal and wafer manufacturers, production of Silicon carbide powders for the PVT process thereof has been internalized.

Acheson method has been widely used as a representative method for producing silicon carbide powders. Acheson method has an advantage in that it can economically produce a large amount of silicon carbide powder using a simple process and inexpensive starting materials. However, the produced silicon carbide has a purity of 99.99% or less and is in the form of a silicon carbide ingot. Thus, since a powdering process of the silicon carbide ingot is required to produce silicon carbide powders. Impurities may be introduced during the process, and thus it is necessary to perform additional purification processes such as acid cleaning. Accordingly, silicon carbide powders produced by the Acheson method is not high in purity, and thus application thereof as a raw material for producing silicon carbide for single crystal by the PVT process is limited.

U.S. Pat. No. 5,863,325 (Patent Document 01) discloses the synthesis of large granular high-purity silicon carbide powder having several ppm of metal impurities, and describes an optimized heat-treatment process to produce silicon carbide powders for the starting material for single crystal growing by a PVT process. In the invention of Patent Document 01, β-phase silicon carbide powder was prepared at 1800° C. and then thermally cycled 3 to 6 times at a temperature of 1900 to 2100° C. to increase the particle size of the powder to about 200 μm, but a long heat-treatment time and a complicated heat treatment process in which a cycle is repeated several times have been noted as disadvantages.

In addition, U.S. Patent Publication No. 6,627,169 (Patent Document 02) discloses a technique of controlling the average particle size of silicon carbide powder by measuring the amount of CO gas generated during a carbothermal reduction process, but the disclosed technique does not satisfy the size of silicon carbide powder required for the SiC single crystal growth by a PVT process.

In addition, Korean Patent No. 10-1678622 (Patent Document 03) proposes a method in which a silicon dioxide/carbon porous composite is formed, metallic silicon is added thereto, and then the mixture is first heated at a temperature of 1200 to 1400° C. and finally heat-treated at a temperature of about 1800° C.

In addition, Korean Patent Application Publication No. 10-2015-0123114 (Patent Document 04) discloses a method of producing α-phase or β-phase silicon carbide powder having a size of 1 to 300 μm by forming fine silicon carbide powder from a mixture of a carbon source and a silicon source through a carbonization process (800 to 1100° C.) and a synthesis process (about 1900° C.), and then adding a carbon source thereto, followed by heat treatment at a temperature of 2100 to 2200° C.

The above-described conventional methods have a problem in that it is difficult to economically produce large granular silicon carbide powders because processes, such as repeated heat treatment and additional mixing of raw materials, are required in the production of large granular silicon carbide powders. Therefore, there is a need for an improved process capable of economically producing large granular high-purity α-phase silicon carbide powder.

### SUMMARY OF THE DISCLOSURE

It is an object of the present disclosure to provide a method for producing large granular high-purity α-phase silicon carbide powders, which overcomes the above-described problems with the conventional methods for producing large granular high-purity silicon carbide powder, such as the use of high-purity starting materials, complex production processes, and the need to improve the yield and purity of large granular silicon carbide powders.

Another object of the present disclosure is to provide large granular high-purity α-phase silicon carbide powders produced by the method.

To achieve the above objects, the present disclosure provides a method for producing large granular high-purity α-phase silicon carbide powders, which includes following steps of:

(i) Producing a gel in which the carbonaceous compound is dispersed in a silicon dioxide network structure through a sol-gel process using starting materials including liquid phase silicon containing compounds and carbonaceous compounds;

(ii) subjecting the gel to first heat treatment to thermally decompose the carbonaceous compound, thereby producing a silicon dioxide/carbon composite including nano-sized carbon particles; and

(iii) subjecting the silicon dioxide/carbon composite to second heat treatment at a higher temperature than that of the first heat treatment to obtain large granular high-purity α-phase silicon carbide powders.

The silicon containing compound may include one selected from the group consisting of tetraethyl orthosilicate (TEOS), tetramethyl orthosilicate (TMOS), and combinations thereof.

The carbonaceous compound may include one selected from the group consisting of phenolic resin, sucrose, maltose, fructose, lactose, polyimide, xylene, and combinations thereof.

The molar ratio of carbon atom to Si atom (C/Si) in the starting materials may be 1:1.6 to 3.0.

The sol-gel process may be performed by introducing the starting materials into a solvent and adding a catalyst thereto, followed by stirring.

The catalyst may include an acid selected from the group consisting of oxalic acid, maleic acid, nitric acid, hydrochloric acid, acrylic acid, toluene sulfonic acid, and combinations thereof; or a base selected from the group consisting of an alkali metal hydroxide, ammonia water, hexamethylenetetramine, and combinations thereof.

The stirring may be performed at a speed of 400 to 2,000 RPM and a temperature of 25 to 60° C.

The method may further include a step of drying the gel before subjecting the gel to first heat treatment.

The first heat treatment may be performed by heating the gel to the temperature of 1,100 to 1,250° C. at a heating rate of 2 to 5° C./min to produce the silicon dioxide/carbon composite.

The average size of the carbon particles included in the silicon dioxide/carbon composite may be 5 nm or less.

The method may further include a step of classifying the silicon dioxide/carbon composite to a size of 300 μm or less, before subjecting the silicon dioxide/carbon composite to the second heat treatment.

The second heat treatment may be performed by heating the silicon dioxide/carbon composite to the temperature of 2,000 to 2,100° C. at a heating rate of 5 to 15° C./min to obtain large granular high-purity α-phase silicon carbide powders.

The method may be free of introduction of additional raw materials.

The large granular α-phase silicon carbide powder may have an average particle size of 70 to 500 μm, a particle size distribution (d₉₀/d₁₀) of 5 or less, and a purity of 99.9995 wt % or more.

### DETAILED DESCRIPTION

The present disclosure relates to a silicon dioxide/carbon (SiO₂—C) composite which is produced using a liquid phase silicon containing compound and a liquid phase carbonaceous compound as raw materials and in which nano-sized carbon particles produced by thermal decomposition of the carbonaceous compound are uniformly distributed, and a method for producing the same.

In addition, the present disclosure relates to large granular high-purity α-phase silicon carbide powders which are produced by subjecting the silicon dioxide/carbon (SiO₂—C) composite to carbothermal reduction by a heat treatment process at the specific temperature, and a method for producing the same. The method for producing a silicon dioxide/carbon (SiO2—C) composite according to the present disclosure, in which nano-sized carbon particles are uniformly distributed, and the method for producing large granular high-purity α-phase silicon carbide powder, include a series of steps as follows:

(i) a step for the fabrication of gel, in which the carbonaceous compound is uniformly dispersed in a silicon dioxide network structure, by hydrolyzing and gelation through a sol-gel process using starting materials including liquid phase silicon containing compound and liquid phase carbonaceous compound;

(ii) steps for drying the gel and subjecting the dried gel to a first heat treatment in which the dried gel is heated to a temperature of 1,100 to 1,250° C. at a heating rate of 2 to 5° C./min, thereby producing a silicon dioxide/carbon composite in which nano-sized carbon nanoparticles produced by thermal decomposition of the carbonaceous compound are uniformly distributed; and

(iii) a step for subjecting the silicon dioxide/carbon composite to carbothermal reduction by a second heat treatment process in which the silicon dioxide/carbon composite is heated to the temperature of 2,000 to 2,100° C. at a heating rate of 5 to 15° C./min under an inert atmosphere or a vacuum atmosphere, thus obtaining large granular high-purity α-phase silicon carbide powders.

Hereinafter, the present disclosure will be described in detail with reference to one embodiment thereof.

In step (i) of the present disclosure, a liquid phase silicon containing compound and a liquid phase carbonaceous compound are used as starting materials, and these starting materials are mixed together, and a catalyst is added thereto, and the resulting mixture is subjected to a sol-gel process to hydrolyze the silicon containing compound, thereby producing a gel in which the carbonaceous compound is uniformly dispersed in a silicon dioxide network structure.

According to a preferred embodiment of the present disclosure, the liquid phase silicon containing compound that is used in the present disclosure may be one or more selected from all silicon alkoxides and polyethyl silicate. Specifically, the silicon containing compound may include one selected from the group consisting of tetraethyl orthosilicate (TEOS), tetramethyl orthosilicate (TMOS), and combinations thereof.

According to a preferred embodiment of the present disclosure, the carbonaceous compound that is used in the present disclosure may be one or more selected from phenolic resins and polysaccharides, which are organic carbon compounds. Specifically, the carbonaceous compound may include one selected from the group consisting of phenolic resin, sucrose, maltose, fructose, lactose, polyimide, xylene, and combinations thereof.

According to a preferred embodiment of the present disclosure, the molar ratio of carbon atom to Si atom (C/Si) in the starting materials may be 1:1.6 to 3.0. As the molar ratio of carbon atom to Si atom (C/Si) increases, the particle size of the produced silicon carbide powder tends to decrease slightly. Meanwhile, if the molar ratio of C/Si is less than 1.6, the synthesis yield of silicon carbide may decrease rapidly, and if the molar ratio of C/Si is more than 3.0, an excessive amount of carbon may suppress the phase transformation of silicon carbide, making it difficult to produce large granular α-phase silicon carbide powder by the phase transformation of β-phase silicon carbide powder, and thus the produced silicon carbide powder may have a small particle size and a wide particle size distribution (d₉₀/d₁₀).

The mixing of the starting materials may be achieved by performing stirring at room temperature (approximately 25° C.) to 60° C. at a speed of 400 to 2,000 RPM according to a conventional stirring method to produce a sol in homogeneous liquid state.

According to a preferred embodiment of the present disclosure, the present disclosure is characterized in that stirring in the process of mixing the starting materials together is performed at a higher speed than a common stirring speed. The reason why stirring is performed at a higher speed than a common stirring speed is to make the size of the carbon source contained in the carbonaceous compound small and uniform, thereby distributing the carbon source uniformly in the silicon dioxide network structure.

According to a preferred embodiment of the present disclosure, the solvent that is used to dissolve the starting materials is water, alcohol, or an aqueous alcohol solution. The solvent may be used in an amount of 10 moles or less, preferably 1 to 5 moles, based on 1 mole of the silicon containing compound. Specifically, the solvent may be water, methanol, ethanol, an aqueous methanol solution, or an aqueous ethanol solution. In addition, in order to uniformly mix the starting materials together and prevent the inclusion of impurities, Teflon having little reactivity with metals and metal compounds may be coated on all containers and devices for mixing.

According to a preferred embodiment of the present disclosure, when the starting materials are mixed together and stirred, an acid or base aqueous solution may be added as a catalyst for hydrolysis and gelation of the silicon containing compound. The acid or base aqueous solution may be obtained by mixing an acid or base with water such that the molar ratio of the acid or base relative to the silicon (Si) element in the silicon containing compound is 0.2 or less, specifically 0.01 to 0.2, and such that the molar ratio of water is 10 or less, specifically 1 to 10.

According to a preferred embodiment of the present disclosure, the acid that is used as a catalyst in the hydrolysis and gelation of the silicon containing compound may include one selected from the group consisting of oxalic acid, maleic acid, nitric acid, hydrochloric acid, acrylic acid, toluenesulfonic acid, and combinations thereof, and the base that is used as a catalyst in the hydrolysis and gelation of the silicon containing compound may include one selected from the group consisting of alkali metal hydroxides (typically sodium hydroxide), ammonia water, hexamethylenetetramine, and combinations thereof.

In step (ii) of the present disclosure, the gel is dried, and the dried gel is heat-treated at 1,100 to 1,250° C. for a specific period of time, thereby producing a silicon dioxide/carbon composite in which nano-sized carbon particles produced by thermal decomposition of the carbonaceous compound are uniformly distributed.

According to a preferred embodiment of the present disclosure, the gel may be placed in distilled water to dilute the alcohol component, and may then be dried at a temperature of 40 to 80° C. in an oven or the like, and the dried gel may be subjected to a first heat-treatment in which the dried gel is heated to a temperature of 1,100 to 1250° C. at a heating rate of 2 to 5° C./min under an inert atmosphere or a vacuum atmosphere and maintained at this temperature for 0.5 to 3 hours, thereby producing a silicon dioxide/carbon (SiO₂—C) composite in which nano-sized carbon particles are uniformly dispersed.

The silicon dioxide/carbon (SiO₂—C) composite produced through the production method described above may be one in which carbon particles having a size of 5 nm or less are uniformly distributed in a silicon dioxide network structure.

The silicon dioxide/carbon composite produced as described above may preferably be used as a raw material for the production of large granular high-purity α-phase silicon carbide powders according to the present disclosure.

Meanwhile, according to a preferred embodiment of the present disclosure, the silicon dioxide/carbon composite may be classified to have a specific size before being used as a raw material for large granular high-purity α-phase silicon carbide powders. This size classification is to uniform the particle size distribution (d₉₀/d₁₀) of the finally obtained large granular α-phase silicon carbide powders. For example, the silicon dioxide/carbon composite may be classified to have a size of 300 μm or less, which may be subjected to the second heat treatment to be described later.

Step (iii) of the present disclosure is a process of subjecting the silicon dioxide/carbon composite to a second heat treatment in which the silicon dioxide/carbon composite is heated to the temperature of 2,000 to 2,100° C. at a heating rate of 5 to 15° C./min under an inert atmosphere or a vacuum atmosphere. High-purity granular α-phase silicon carbide powders are produced by carbothermal reduction of this step.

According to a preferred embodiment of the present disclosure, the silicon dioxide/carbon composite may be placed at a high filling rate in a high-purity vacuum furnace such as a high-purity graphite vacuum furnace, and may then be subjected to second heat treatment under an inert argon atmosphere or a vacuum (10⁻¹ Torr or less) atmosphere, whereby large granular high-purity α-phase silicon carbide powder having a narrow particle size distribution may be produced to have a desired average particle size by controlling the heat-treatment temperature and time.

According to a preferred embodiment of the present disclosure, the second heat-treatment process for producing large granular α-phase silicon carbide powder may be the heat-treatment process in which the silicon dioxide/carbon composite is heated to the temperature of 2,000 to 2,100° C. at a heating rate of 5 to 15° C./min under an inert atmosphere or a vacuum atmosphere and maintained at that temperature for 10 minutes to 5 hours.

According to a preferred embodiment of the present disclosure, the silicon carbide powder produced by the above-described method may have an average particle size of 70 to 500 μm, a uniform particle size distribution (d₉₀/d₁₀) of 5 or less, an metallic impurity content of 10 ppm or less, and a purity of 99.9995 wt %.

According to the present disclosure, a gel in which a carbonaceous compound is uniformly dispersed in a silicon dioxide network structure may be produced through a sol-gel process, and a silicon dioxide/carbon composite in which nano-sized carbon particles produced by thermal decomposition are uniformly distributed may be produced by drying and heat-treating the produced gel, and large granular high-purity α-phase silicon carbide powder may be produced using the silicon dioxide/carbon composite.

According to the present disclosure, it is possible to effectively control the size of large granular high-purity α-phase silicon carbide powder by varying the composition of the starting materials and the temperature and heating time of the heat treatment process.

According to the present disclosure, it is possible to produce large granular high-purity α-phase silicon carbide powder having a size of up to 500 μm by excluding a process of introducing additional raw materials to synthesize high-purity granular α-phase silicon carbide powder and performing carbothermal reduction through a simple heat-treatment process without repeated heat treatment cycles. Thus, the reliability of the silicon carbide powder production process may be increased, and the produced silicon carbide powder may be highly economical and widely applicable to single-crystal growth processes.

Therefore, the present disclosure may lower the production cost of ultra-high purity silicon carbide powder due to process advantages, and may thus have an economic effect of lowering the cost of producing a silicon carbide single-crystal wafer for a power semiconductor by a conventional physical vapor transport (PVT) method.

Hereinafter, the present disclosure will be described in detail based on examples, but the scope of the present disclosure is not limited by the examples.

### EXAMPLES 1 to 3

To produce large granular high-purity α-phase silicon carbide powder, tetraethyl orthosilicate (TEOS) having metallic impurity content of 20 ppm or less was used as a liquid phase silicon containing compound, and a solid state phenol resin (novolac type) having a metallic impurity content of about 100 ppm was used as a carbonaceous compound. The TEOS and the phenol resin were prepared in consideration of the amount of carbon remaining after heat treatment such that the molar ratio of carbon atom to Si atom (C/Si) in starting materials was 1:1.6 to 3.0.

Specifically, according to the content ratio shown in Table 1 below, the carbonaceous compound and the silicon containing compound were mixed together and stirred. That is, phenol resin was dissolved in 4 moles of ethanol relative to 1 mole of Si atom in the silicon containing compound, and then TEOS was added to the solution, which was then sufficiently mixed and stirred at a stirring speed of 2000 rpm at room temperature.

To the sufficiently mixed starting material solution, an aqueous nitric acid solution obtained by mixing 0.07 mol of nitric acid and 2 mol of water relative to 1 mol of Si atom in the silicon containing compound was added, and the mixture was stirred at room temperature until a gel was formed.

The gel in which the phenol resin was uniformly dispersed was placed in high-purity distilled water to lower the alcohol content, and the gel was dried at about 80° C. for about 24 hours. The dried gel was placed in a high-purity graphite crucible which was then placed in a quartz reactor. Then, the dried gel was subjected to a first heat treatment in which the gel was heated to 1,200° C. at a rate of 5° C./min under a nitrogen gas atmosphere and maintained at that temperature for 0.5 hours, thereby producing a silicon dioxide/carbon (SiO₂—C) composite. The size of the thermally decomposed carbon in the above-produced silicon dioxide/carbon composite was 2 nm or less, and the silicon dioxide/carbon composite was classified to have a size of 300 μm or less and used in a heat-treatment process for producing large granular α-phase silicon carbide powder.

The above classified silicon dioxide/carbon composite was placed in a high-purity graphite crucible at a filling rate of 60% and charged into a high-purity graphite furnace. Then, the classified silicon dioxide/carbon composite was subjected to a second heat treatment in which the composite was heated to the temperature of 2,000° C. at a rate of 10° C./min under a vacuum atmosphere (10⁻² Torr) and maintained at that temperature for 3 hours, thereby producing large granular α-phase silicon carbide powder.

The properties of the large granular α-phase silicon carbide powders produced using the silicon dioxide/carbon composites in Examples 1 to 3 are summarized in Table 1 below.

TABLE 1

| | | Example | | |
|---|---|---|---|---|
| | | 1 | 2 | 3 |
| Starting | C atom in carbon source (mol) | 1.6 | 2.3 | 3.0 |
| materials | Si atom in silicon source (mol) | 1 | 1 | 1 |
| | C/Si (molar ratio) | 1.6 | 2.3 | 3.0 |
| Nitric acid | Nitric acid (mol) | 0.07 | 0.07 | 0.07 |
| aqueous | Water (mol) | 2 | 2 | 2 |
| solution | | | | |
| α-Silicon | Average particle size (μm) | 90 | 100 | 150 |
| carbide | Particle size distribution (d₉₀/d₁₀) | 4.1 | 4.3 | 4.5 |

| | | |
|---|---|---|
| powder | Purity (GDMS, wt %) | 99.9995 to 99.9998 |

### EXAMPLES 4 and 5

A silicon dioxide/carbon composite was produced in the same manner as in Example 1, except that the molar ratio of carbon atom to Si atom (C/Si) in the starting materials was fixed to 2.3.

The silicon dioxide/carbon composite was placed in a high-purity graphite crucible at a filling rate of 60% and charged into a high-purity graphite furnace. Then, the silicon dioxide/carbon composite was subjected to a second heat treatment in which the composite was heated to 2,100° C. at a heating rate of 10° C./min under a vacuum atmosphere (10⁻² Torr) and maintained at that temperature for each of 1 hour and 3 hours, thereby producing large granular high-purity α-phase silicon carbide powder.

The properties of the large granular α-phase silicon carbide powders produced using the silicon dioxide/carbon composites in Examples 4 and 5 are summarized in Table 2 below.

TABLE 2

| | | Example | |
|---|---|---|---|
| | | 4 | 5 |
| Heat treatment | Atmosphere | Vacuum | Vacuum |
| | Heating rate (° C./min) | 10 | 10 |
| | Peak temperature (° C.) | 2100 | 2100 |
| | Heating time (h) | 1 | 3 |
| α-Silicon | Average particle size (μm) | 250 | 450 |
| carbide powder | Particle size distribution | 2.5 | 3 |
| | (d₉₀/d₁₀) | | |
| | Purity (GDMS, wt %) | 99.99995 | 99.99994 |

As described above, the large granular α-phase silicon carbide powder according to the present disclosure may be applied as a raw material for the fabrication process of a silicon carbide single crystal by the PVT method.

According to the production method of the present disclosure, large granular high-purity α-phase silicon carbide powder having an average particle size of 70 to 500 μm, a uniform particle size distribution of (d₉₀/d₁₀) of 5 or less, and an impurity content of 10 ppm or less may be produced through a simplified process without a complicated heat-treatment process or a process of introducing additional raw materials, making it possible to improve economic efficiency and yield.

In addition, according to the production method of the present disclosure, it is possible to effectively control the size, particle size distribution, and purity of silicon carbide powder by changing the composition of the silicon source and the carbon source that are used for the production of the silicon dioxide/carbon composite and controlling the heat-treatment temperature and the heating time.

What is claimed is:

1. A method for producing large granular high-purity α-phase silicon carbide powders, the method comprising steps of:
(i) producing a gel in which the carbonaceous compound is dispersed in a silicon dioxide network structure through a sol-gel process using starting materials including liquid phase silicon containing compounds and liquid phase carbonaceous compounds;
(ii) subjecting the gel to first heat treatment to thermally decompose the carbonaceous compound, thereby producing a silicon dioxide/carbon composite including nano-sized carbon particles; and;
(iii) subjecting the silicon dioxide/carbon composite to second heat treatment at a higher temperature than that of the first heat treatment to obtain large granular high-purity α-phase silicon carbide powders.

2. The method of claim 1, wherein the silicon containing compound comprises one selected from the group consisting of tetraethyl orthosilicate (TEOS), tetramethyl orthosilicate (TMOS), and combinations thereof.

3. The method of claim 1, wherein the carbonaceous compound comprises one selected from the group consisting of phenolic resin, sucrose, maltose, fructose, lactose, polyimide, xylene, and combinations thereof.

4. The method of claim 1, wherein a molar ratio of carbon atom to Si atom (C/Si) in the starting materials is 1:1.6 to 3.0.

5. The method of claim 1, wherein the sol-gel process is performed by introducing the starting materials into a solvent and adding a catalyst thereto, followed by stirring.

6. The method of claim 5, wherein the catalyst comprises:
an acid selected from the group consisting of oxalic acid, maleic acid, nitric acid, hydrochloric acid, acrylic acid, toluenesulfonic acid, and combinations thereof; or
a base selected from the group consisting of an alkali metal hydroxide, ammonia water, hexamethylenetetramine, and combinations thereof.

7. The method of claim 5, wherein the stirring is performed at a speed of 400 to 2,000 RPM and a temperature of 25 to 60° C.

8. The method of claim 1, further comprising a step of drying the gel, before subjecting the gel to the first heat treatment.

9. The method of claim 1, wherein the first heat treatment is performed by heating the gel to the temperature of 1,100 to 1,250° C. at a heating rate of 2 to 5° C./min to produce the silicon dioxide/carbon composite.

10. The method of claim 1, wherein the carbon particles included in the silicon dioxide/carbon composite have an average particle size of 5 nm or less.

11. The method of claim 1, further comprising a step of classifying the silicon dioxide/carbon composite to a size of 300 μm or less, before subjecting the silicon dioxide/carbon composite to the second heat treatment.

12. The method of claim 1, wherein the second heat treatment is performed by heating the silicon dioxide/carbon composite to the temperature of 2,000 to 2,100° C. at a heating rate of 5 to 15° C./min to obtain large granular high-purity α-phase silicon carbide powders.

13. The method of claim 1, which is free of introduction of an additional raw material.

14. The method of claim 1, wherein the large granular α-phase silicon carbide powder has an average particle size of 70 to 500 μm, a particle size distribution (d₉₀/d₁₀) of 5 or less, and a purity of 99.9995 wt % or more.
